(19) United States
(12) Patent Application Publication
(10) Pub. No.: US 2003/0036009 A1
(43) Pub. Date: Feb. 20, 2003

(54) Method for producing developed electrostatic images using multiple toner fountains

(75) Inventors: Romit Bhattacharya, Morris Plains, NJ (US); Giovanni Perrotta, Wayne, NJ (US); Daryl Schelin, Las Vegas, NV (US)

Correspondence Address: PENNIE AND EDMONDS, 1155 AVENUE OF THE AMERICAS, NEW YORK, NY, 100362711

(73) Assignee: Specialty Toner Corporation

(21) Appl. No.: 10/256,217

(22) Filed: Sep. 25, 2002

Related U.S. Application Data
(63) Continuation of application No. 09/482,770, filed on Jan. 13, 2000, now abandoned.
(60) Provisional application No. 60/146,331, filed on Jul. 30, 1999.

(51) Int. Cl. G03G 13/01

(52) U.S. Cl. 430/45; 430/18; 430/117

(57) ABSTRACT

The present invention is to a method of producing a high resolution image on an electrostatic printer by (a) providing an electrostatic printer having at least five toner fountains; (b) providing a set of at least five liquid toners each having a desired color, the set comprising at least one reduced density toner and at least one dark toner, where the reduced density toner is either white or has the same color, but a lower color density, as at least one other toner in the set, and the dark toner is either black or has the same color but a higher color density as at least one other toner in the set; (c) forming an electrostatic image on a substrate that corresponds to that portion of a final image that is formed from one of the toner colors; (d) developing the electrostatic image with the appropriate color toner; and (e) forming the final image by repeating (b) and (c) for each color toner.

The present invention relates to electrostatic printing using a plurality of toner fountains for at least five different color liquid toners, where, preferably, the five toners are either magenta, cyan, yellow, black, and white or cyan, reduced density cyan, magenta, reduced density magenta, and yellow. Optionally, additional toner fountains may be utilized to print with additional toners, such as black, a lighter or darker yellow, spot colors, such as red, green, and blue, or speciality toners, such as “neon” and fluorescent colors.

### BACKGROUND OF THE INVENTION

Use of liquid toners for electrostatography, i.e., the production of a visible, permanent image from a latent image consisting of a pattern of electrostatic charges, is well known. Liquid toners are typically used to develop electrostatic images in imaging systems that incorporate features similar to those of dry toner based copier and printer systems. However, liquid toner particles are significantly smaller than dry toner particles, i.e., typically less than about 3 micrometers (μm), and are capable of producing toned images having very high resolution. Therefore, liquid toners have a number of advantages over dry toners, including the production of sharper and better defined images, a higher degree of and more delicate gradations of contrast, and cleaner whites. Liquid toners can also provide for a more economical use of the toner, a faster developing cycle, and simpler, less expensive and more trouble-free developing equipment.

Liquid toners are generally used to produce an image by the selective deposition of a pigment on a substrate to form a visible pattern. Although liquid toners are typically used in liquid electrostatic developers for electrostatic printers and copiers, they can also be used in ink-jet printers, as well as equipment for high-speed print-outs and reproductions of microfilms, facsimile printing, and instrument recordings. Images produced with liquid toners include pictures, e.g., half-tone pictures, line pictures, and photographic reproductions, as well as symbols, digits, graphs, and letters, i.e., any image that can be produced on an analog or digital electrostatic copier or printer. In particular, liquid toners are increasingly used to produce signs, posters, and charts for seminars and corporate events and meetings, binder cover inserts, packaging, short-run labels, store window display graphics, and outdoor billboards.

Typically, liquid toners have two phases, a continuous phase of a liquid hydrocarbon solvent system and a dispersed phase of dispersed pigments. The liquid hydrocarbon system has a high electrical resistivity, i.e., greater than 10⁹ ohm·cm. This high resistivity does not allow the electrostatic charges on the substrate, typically a copy sheet or an electrostatic or xeroprinting master, to bleed off before the image is formed, thus maintaining the desired degree of contrast.

The liquid hydrocarbons should evaporate quickly, so that a thin film will evaporate in a few seconds at a temperature below the char point of paper, and should dry fully, so that a liquid-free pigment film is deposited. The liquid hydrocarbon system should be nontoxic when the vapor is inhaled or when the liquid comes in contact with skin, substantially odor free, and physically and chemically inert with respect to the copy sheet. A low viscosity is desirable, since this allows the dispersed phase to migrate through the continuous phase as a result of an attraction to an electrostatically charged substrate, to form an image by coupling with a pattern of electrostatic charges on the substrate. The continuous phase contains dissolved and suspended solids, including pigments, a fixative or fixing agent, typically a thermoplastic resin having the ability to flow under heat to fuse the deposited material to the substrate surface, and increase the bond between the deposited material and the substrate. Dissolved and suspended solids also include a dispersant, typically a long chain organic compound, such as a synthetic polymer, having both oil soluble and polar groups, to aid in the dispersion of suspended particles, and a charge director, typically a metallic derivative of a fatty acid or resin acid. The charge director is absorbed by individual pigment particles, which causes the pigment particles to aggregate in the dispersed phase. The dispersion of the aggregates formed is stabilized by the dispersant by an entropic repulsion mechanism.

The charge director also acts as an ionic surfactant, which forms inverse micelles in low dielectric media, such as the liquid hydrocarbon solvent system, and produces an electrostatic charge on particles dispersed in the continuous phase. Although a number of mechanisms are believed to be involved in the spontaneous separation of charges between the dispersed particles and the micelles, the acid-base chemistry of the dispersed particles and the ionic surfactant micelles is believed to play a major role in the production of charged particles, so that a proton or cation exchange from the particles to the micelles occurs when negatively charged particles are produced, and from the micelles to the particles when positively charged particles are produced. In addition, an electrode may be used to induce an electrostatic charge in the toner particles prior to their application to a substrate. The charge on the particles can be selected by the appropriate choice of charge director.

Electrographic and electrophotographic processes are well known, and are described by Steven P. Schmidt et al., Handbook of Imaging Materials, Chap. 6, 227-252 (1991). There are the numerous variations of these processes, all of which incorporate the same basic steps of creating an electrostatic image on a substrate, developing the image with charged, colored particles, i.e., toner, optionally transferring the resulting developed image to a secondary substrate, and fixing the image to the substrate.

The first basic step, the creation of an electrostatic image, can be accomplished by a variety of methods. In the electrophotographic process, the electrostatic image is formed by a discharge of a uniformly charged photoconductor. The discharge occurs when the uniformly charged photoconductor is exposed to light, which may be reflected from or transmitted through an image that is being copied, or be provided by a laser in a digital laser copier or printer. The exposure may be analog or digital, and the photoconductor may be single use or rechargeable and reimageable. Single use devices may be repeatedly charged and developed after a single exposure, but are permanently imaged by the exposure. With both the single use and rechargeable devices, the electrostatic image is created by corona charging a photoconductor, followed by image wise exposure and photodischarge. The electrostatic image is then developed with liquid toner having either positively or negatively charged particles, and transferred electrostatically to plain paper. The photoconductor may then be cleaned, charged, and reimaged.

In one form of the electrostatic process, a photosensitive element is permanently imaged to form areas of differential conductivity. The electrostatic image is created by uniform electrostatic charging followed by differential discharge of the imaged element. The electrographic or xeroprinting elements or masters can be repeatedly charged and developed after a single imaging exposure.

In an alternative electrographic process, electrostatic images are created ionographically. The latent image is created on a dielectric medium, such as paper or film, which is capable of holding a charge, by applying a voltage to one or more members of an array of electronic writing styluses or nibs. The styluses or nibs are selected in a manner that will produce the desired image when ions are produced from the applied voltage, placing a charge, and forming the latent image on the dielectric medium.

However the electrostatic image is produced, the image is developed with toner particles that possess a charge opposite to that of the charged surface to which they arc applied. With liquid toners, a flowing liquid ensures the availability of sufficient toner particles to develop the image. When the flowing liquid is brought into direct contact with the electrostatic image, the charge of the electrostatic image creates a field that causes the charged toner particles to move through the nonconductive continuous phase by electrophoresis. As the charged toner particles contact the latent electrostatic image, the charge of the image is neutralized by the oppositely charged toner particles, and a layer of pigment is deposited, forming a permanent image.

If a reimageable photoreceptor or an electrographic master is used, the developed image must be transferred to paper or other substrate. To transfer the image, the substrate is charged electrostatically with the polarity chosen to cause the toner particles to transfer to the substrate. The substrate is then brought in contact with the reimageable photoreceptor or an electrographic master to produce the final image on the desired substrate.

Finally, the toned image must be fixed to the substrate. For self-fixing toners, residual solvent is removed from the substrate by air-drying or heating. The evaporation of the solvent results in a toner film that is bonded to the paper. For heat fusible toners, thermoplastic polymers are incorporated in the toner particles. Heating removes any residual solvent and fixes the toner to the substrate.

For color images, in prior art printing methods, four different liquid toners having different colored pigments are used individually in four separate passes through the developer. Color printers typically have four separate sources of toner, which are typically referred to as toner fountains, one for each of the colored toners, i.e., one for black and one for each of the primary colors used in color developing: magenta, cyan, and yellow. However, there are commercially available printers that include a fifth fountain for an additional toner. On each pass of the substrate through the developer, the latent image is formed in a manner such that only that part of the image that is of a particular color is deposited on any given pass. After the fourth pass, the four toners form a full color image.

Prior art four-color electrostatic printing is described in U.S. Pat. No. 5,899,604 to Clark (“the '604 patent”), the contents of which are incorporated herein in their entirety by reference. The '604 patent also teaches printing with seven or eight colors, but is only enabling for inkjet printers.

Recently, manufacturers of electrostatic printers such as RasterGraphics (Orchard Parkway, San Jose, Calif.) and 3M (St. Paul, Minn.) have introduced 54 inch wide printers with 5 inking fountains. The initial purpose for the additional fountain was to utilize “Spot Color” toners (i.e. toners with a specific color to achieve an exact solid color without the need for half toning or “dithered dots”), “Neon”, or “Fluorescent” toners. The additional fountain can also be used to apply a protective overcoat on the electrostatic print by applying a “digital varnish” as described in U.S. Pat. No. 5,744,269 to Bhattacharya et al., the contents of which are incorporated herein in their entirety by reference.

Large format electrostatic printing has evolved over the past 12 years with applications ranging from Point-of-Purchase displays, signs and banners, trade show graphics, outdoor billboards, fleet graphics, bus shelters, wall paper, vinyl flooring, and backlit displays to name a few. These prints are produced by using pigment based color liquid toners. Over the past three years, new toners incorporating dispersed sublimable dyes have dramatically increased the applications for electrostatic printing. By imaging first on electrostatic paper and then applying heat, pressure and time, these images can be transferred onto a wide variety of other substrates, including, but not limited to a wide variety of polyester fabrics, MYLAR®, and TYVEK®. However, at present, a dye for a white sublimation toner is not available. By applying a coating of polyester, polyurethane or acrylic resin, these images formed with sublimation toners can also be transferred to, for example, wood, metal, plastic, glass, porcelain, ceramic tiles, stone, PLEXIGLAS®, concrete board, high pressure and low pressure laminate, and CORIAN®, to name just a few materials.

While the dye sublimation process has allowed a greater range of applications, the image quality inherent in 4-color electrostatic printing with its grainy dots and color gradations and inability to produce acceptable midtones has prevented acceptance of such prints in various markets where close viewing is a requirement. Those markets include, but are not nearly limited to, apparel printing, decorative ceramic tiles, home furnishing and upholstery, wall coverings, and fine art reproduction.

Four-color electrostatic printing methods are known in the art. For example, U.S. Pat. No. 4,181,423 to Pressman et al. discloses a method and an apparatus for modulated aperture electrostatic half tone printing using modulated ion streams and transparent toners. Color images are formed by overlaying black, magenta, cyan, and yellow images to form a full color image, where additional colors, such as metallics, may be added for special effects.

U.S. Pat. No. 4,777,576 to Fur et al. discloses a method and an apparatus for pattern generation on a dielectric substrate to produce a full color image from four process colors. A five color unit may be used to apply silver, gold, magnetic, or other special-purpose ink or coating.

U.S. Pat. No. 5,749,032 to Landa et al. discloses a color imaging system in which separate yellow, magenta, cyan, and black liquid toners are supplied from four different reservoirs.

U.S. Pat. No. 5,953,566 to Fujiwara et al. discloses an electrographic color image forming method and apparatus in which a plurality of liquid developing devices accommodating liquid developer comprising colored microparticles dispersed in an electrically insulated fluid medium are used to form toner images of different colors, i.e., cyan, yellow, magenta, and black, which are electrostatically transferred and overlaid to produce an overlaid toner image on a substrate.

However, none of those methods provides the image quality required for close viewing. Therefore, a need exists for a method of multi-color electrostatic printing that overcomes the prior art deficiencies in image quality, which produces a smooth, non-grainy image, and allows the highly efficient electrostatic digital printing process to enter a much wider variety of markets. The present invention provides such a method.

### SUMMARY OF THE INVENTION

The present invention is directed to a method of producing a high resolution image on an electrostatic printer. The method comprises (a) providing an electrostatic printer having at least five toner fountains; (b) providing a set of at least five liquid toners each having a desired color, the set comprising at least one reduced density toner and at least one dark toner, where the reduced density toner is either white or has the same color, but a lower color density, as at least one other toner in the set, and the dark toner is either black or has the same color but a higher color density as at least one other toner in the set; (c) forming an electrostatic image on a substrate that corresponds to that portion of a final image that is formed from one of the toner colors; (d) developing the electrostatic image with the appropriate color toner; and (e) forming the final image by repeating (b) and (c) for each color toner. However, where reduced density magenta and reduced density cyan toners are used, a reduced density yellow toner is not used with a standard yellow toner. Preferably, the toner set is selected from the group consisting of a set comprising reduced density cyan, dark cyan, reduced density magenta, dark magenta, and yellow toners and a set comprising black, yellow, cyan, magenta, and white toners. Either reflective toners or dye sublimation toners may be used with the invention to develop the image. Where dye sublimation toners are utilized, a mirror image is first formed on a first substrate. The mirror image is then placed in contact with a second substrate, and heat is applied to transfer the image to the second substrate.

The invention is also directed to a developed electrostatic image on a substrate, where the image comprises at least five layers. Each layer is formed from one toner in a set of at least five liquid color toners, where the set comprises at least one reduced density toner and at least one dark toner. The reduced density toner is either white or has the same color, but a lower color density, as at least one other toner in the set, and the dark toner is either black or has the same color, but a higher color density as at least one other toner in the set. However, where one layer is formed from a reduced density magenta toner, and one layer is formed from a reduced density cyan toner, the image is free of any layers formed from a reduced density yellow toner.

### BRIEF DESCRIPTION OF THE DRAWINGS

FIG. 1 illustrates the application of a toner by the method of the invention, using an electrophotographic printer.

FIG. 2 illustrates the application of a toner by the method of the invention ionographically.

FIG. 3 illustrates a cross section of the transfer of an electrostatic image, formed from dye sublimation toners, from a first substrate to a second substrate.

### DETAILED DESCRIPTION OF THE INVENTION

As used herein, the terms “electrostatic image” and “electrostatic print” refer to any image, picture, half-tone picture, line picture, photographic reproduction, symbol, digit, graph, letter, sign, poster, chart, binder cover insert, packaging, short-run label, store window display graphic, outdoor billboard, or any other type of image produced with any electrostatic method, including electrostatography, electrostatic developers, xeroprinting, xerography, and any other electrographic or electrophotographic method.

Also, as used herein, reference to reduced density cyan (LC) and reduced density magenta (LM) toners refers to toners having those colors and a color density that is less than that of toners used in prior art four color electrostatic printing. Reference to toners other than reduced density toners indicates toners having substantially the same color density as that of toners used in prior art four color electrostatic printing.

The present invention is directed to a method of electrostatic printing using at least five toner fountains, each of which contains a different color toner. The multi-color printing process of the invention utilizes an electrostatic printer having more than 4 toner fountains, such as the 5-fountain DCS 5442 electrostatic printer from RasterGraphics, a raster image processing program (“RIP”), such as that available from Onyx Graphics (Salt Lake, Utah), and at least five specifically designed liquid color toners, such as those available from Specialty Toner Corporation (Fairfield, N.J.).

In a first embodiment, the toners can be characterized as reduced density cyan (LC), dark cyan (DC), reduced density magenta (LM), dark magenta (DM), and yellow (Y), where the reduced density cyan toner has a color density that is less than that of the dark cyan, and the reduced density magenta has a color density that is less than that of the dark magenta. It is contemplated that in this embodiment, when electrostatic printers having six or more printing fountains become available, a Black toner could be incorporated to achieve an even higher color gamut and black color saturation.

In an alternate embodiment, the toners can be characterized as black, white, cyan, magenta, and yellow, where a spot or speciality toner can be used when additional printing fountains become available. This allows a true black to be used, rather than producing black by combining cyan, magenta, and yellow toners.

Nevertheless, by the combined use of the relevant software and the five uniquely formulated toners, the five color process produces an electrostatic print with a dramatically higher dynamic range, wider color gamut, and clearer, more detailed appearance than is achievable with prior art four-color electrostatic printing. The general theory governing how this is achieved is disclosed in U.S. Pat. No. 5,899,604. However, the present invention differs from the process described in the '604 patent by utilizing five specifically designed toners printing once with set contrast levels rather than by using the standard 4 color toners, and printing twice with each toner at different contrast levels.

Presently, as currently available electrostatic printers have a maximum of five toning stations, the multi-color electrostatic printing process of the invention utilizes five-color electrostatic printing. However, the process of the invention can be applied to printing with more than five colors as printers having additional printer fountains become available. For example, with a six color printer, a black liquid toner can be used in combination with reduced density cyan, dark cyan, reduced density magenta, dark magenta, and yellow toners to provide a true black, or a lighter yellow liquid toner or a spot color, such as red, blue or green, in combination with black, white, cyan, magenta, and yellow toners. Similarly, the availability of seven or more colors allows the use of a lighter yellow liquid toner and one or more spot colors, process colors, and/or specialty toners, such as neon or flourescent colors or DIGITAL VARNISH®, available from Specialty Toner Corporation, to provide a protective coating on the surface of the developed image.

As appropriate printers become available, the concept behind the multi-color printing of the invention and the design of the appropriate liquid toners can be extended to take advantage of electrostatic printers with more than five toning stations. Prior to the present invention, electrostatic printing provided higher productivity (6-25 times faster) than Inkjet devices, but lacked the print quality provided by ink jet printers capable of providing six or more colors.

A typical raster image processing program or RIP works in the manner described in U.S. Pat. No. 5,899,604. In the present invention, a RIP, preferably the RIP available from Onyx, is utilized with five customized color toners, such as those available from Specialty Toner Corporation, to achieve an extended dynamic color range in the print output. In order for the process to work properly, several components and conditions must be optimized and interconnected. Although the discussion below is directed to five-color electrostatic printing, it is readily extended to electrostatic printing with more than five colors by one of ordinary skill in the art.

Where five colors are used, the toners are formulated and balanced to provided the appropriate combination of two or more colors required to produce any given secondary color. For example, for dark cyan, dark magenta, reduced density cyan, reduced density magenta, and yellow, a combination of reduced density cyan, dark cyan, and yellow gives green, a combination of reduced density magenta, dark magenta, and yellow gives red, and a combination of reduced density cyan, dark cyan, reduced density magenta, and dark magenta gives blue or purple, where a desired shade of each color is obtained varying the relative amounts of each toner. Similarly, the appropriate combination of all five colors produces either a gray or black depending on the percentage of each color use.

Where the five toners are black, white, cyan, magenta, and yellow, the addition of the white toner is used to create the required gray scale and achieve the color gamut that would otherwise be provided by the reduced density cyan and reduced density magenta. Thus, grey is obtained from a combination of black and white toners, green is obtained from a combination of white, cyan, cyan, and yellow toners, red is obtained from a combination of white, magenta, and yellow toners, and blue and purple are obtained from a combination of white, cyan, and magenta toners. In order to achieve the required color balance using any of the combinations of toners described above, a specific reflective print density must be produced on the paper, film, vinyl, polyester cloth or the other medium or substrate on which electrostatic prints can be applied to produce the final print.

The reflective print density range for each color toner typically used in the present invention, as measured on an X-Rite 404 Reflective Densitometer, typically falls within the following ranges: for black, about 1 to about 1.55, for a normal cyan, about 039 to about 1.35, for reduced density cyan, about 0.6 to about 0.9, dark cyan, from about 1.10 to about 1.40, for a normal magenta, about 1 to about 1.45 for a reduced density magenta, about 0.6 to about 0.9, for a dark magenta, from about 1.10 to about 1.40, and for a normal yellow, from about 0.65 to about 0.85. A white toner, using the paper as a reference, typically has a ΔE of about ±5 relative to the paper.

For dye sublimation toners, reflective print densities on paper, as measured on an X-Rite 404 Reflective Densitometer, prior to image transfer are as follows: for black, about 0.9 to about 1.25, for a normal cyan, about 0.65 to about 1.2, for reduced density cyan, about 0.4 to about 0.65, for dark cyan, from about 0.9 to about 1.2, for a normal magenta, about 0.9 to about 1.25, for a reduced density magenta, about 0.35 to about 0.65, for a dark magenta, from about 0.95 to about 1.35, and for a normal yellow, from about 0.35 to about 0.65. At present, a white dye sublimation toner is not available. However, it is believed that a white dye sublimation toner will eventually be developed for use with the present invention.

Formulations for color electrostatic liquid toners are well known in the art. For the multi-color printing process of the invention, it is necessary to formulate toner that differ from prior art toners to provide the different variations of cyan and magenta in order to achieve the desired results. Reduced density cyan and magenta can be prepared in several ways, including: diluting standard cyan and magenta toners, decreasing the pigment content in the appropriate formulation, or modifying the charge per particle, i.e., the charge/mass ratio, so that fewer charged color pigment/dispersed dye particles are attracted to the opposite latent charge on the electrostatic paper during development of an electrostatic image to yield a lower saturation of cyan and magenta, i.e., “lighter” cyan and magenta.

Similarly, dark cyan and magenta can be produced by taking the opposite route such as: increasing the concentration of the toner, increasing the pigment content in the formulation, or modifying the charge, so that more particles are attracted to the electrostatic image during development to yield a higher saturation of cyan and magenta, i.e., “darker” cyan and magenta.

The output from the toners is linked with the RIP by building and incorporating specific color profiles and a linearization model that allows parity between the image on a RGB monitor and the 5-color electrostatic printer. In addition, as is well known in the art, that external conditions such as relative humidity and temperature must be maintained within a tight range (45-55% RH, 68-74° F.) in order to achieve optimum results from electrostatic printing. Similar restraints apply in developing photographs.

The multi-color electrostatic printing method of the invention may be used with pigment based color liquid toners and with dispersed sublimable dyes. As a result, the invention can be used to produce large format applications, such as point-of-purchase displays, signs and banners, trade show graphics, outdoor billboards, fleet graphics, bus shelters, wall paper, vinyl flooring, and backlit displays, as well as producing images that can be transferred onto a wide variety of other substrates, including, but not limited to a wide variety of polyester fabrics, MYLAR®, and TYVEK® by imaging first on electrostatic paper and then applying heat, pressure and time. In addition, by applying a coating of polyester, polyurethane or acrylic resin, images formed with sublimation toners can also be transferred to, for example, wood, metal, plastic, glass, porcelain, ceramic tiles, stone, PLEXIGLAS®, concrete board, high pressure and low pressure laminate, and CORIAN®, to name just a few materials. As a result, the present invention is useful in apparel printing, decorative ceramic tiles, home furnishing and upholstery, wall coverings, and fine art reproduction. The multi-color printing of the invention overcomes the deficiencies in image quality of the prior art, and allows the highly efficient electrostatic digital printing process to enter a much wider variety of markets. Morever, because the multi-color printing process of the invention produces a smooth, non-grainy image, small format images, such as, e.g., eight inch by ten inch prints, can also be produced with a highly acceptable image quality.

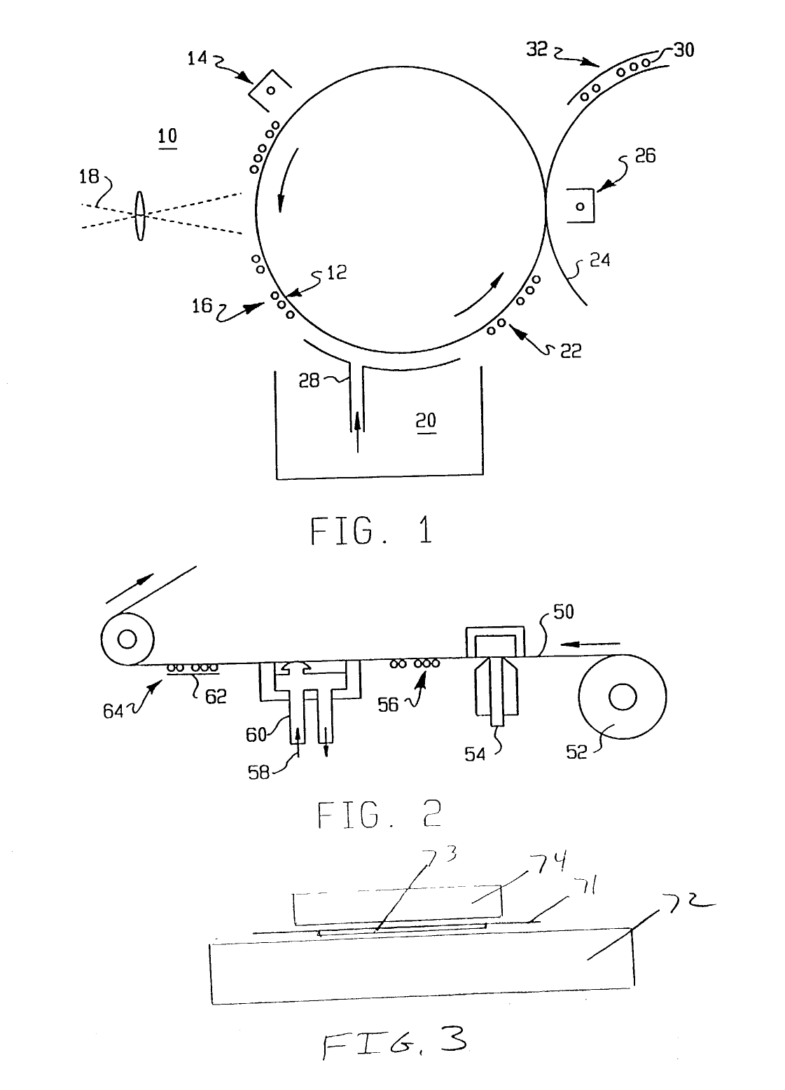

The developed color electrostatic image may be formed on an electrostatic printer using printers and methods well known in the art. FIG. 1 illustrates an electrophotographic device 10 in which photoconductor 12 is uniformly charged by charging source 14. An electrostatic image 16 corresponding to one color in the final image is formed by an analog or digital imagwise photodischarge of charge photoconductor 12. In an analog discharge, the light 18 used to cause the photodischarge is typically reflected from or transmitted through an image being copied. For a digital discharge, the light source is typically a laser, which may be used to digitally scan an image to produce a copy, or may be controlled by a computer to produce a computer created digital image. In either case, the electrostatic image 16 is developed by contacting the image 16 with liquid toner 20 from toner fountain 28, containing a pigment corresponding to the color in the final image. The toned image 22 is then transferred to a substrate 24, such as paper or film, by applying a charge to the substrate from charging source 26. The toned image is attracted to the charge on substrate 24, and forms a final electrostatic image 30. To produce the full color image, one passe through the electrostatic device 10 is required for each toner, as on each pass only that part of the image that corresponds to a specific color is formed. The image is developed with the appropriately colored toner 20 and transferred to substrate 24.

FIG. 2 illustrates an alternative electrographic process, in which an electrostatic image is produced ionographically on a dielectric substrate, e.g., paper or film. Dielectric substrate 50 from dielectric substrate source 52 receives an electrostatic charge from an array of electrostatic writing style or nibs 54, creating electrostatic image 56. As in FIG. 1, the electrostatic image is developed by contact with a liquid toner 58 of the appropriate color from fountain 60 to form a toned image 62.

FIG. 3 illustrates the use of dye sublimation toners, where a mirror image of the final image is first formed on a first substrate, such as paper, with dye sublimation toners, as shown in FIGS. 1 and 2, and then transferred to a second substrate, such as polyester fabrics, MYLAR®, and TYVEK®. However, at present, a dye for a white sublimation toner is not available. By applying a coating of polyester, polyurethane or acrylic resin, these images formed with sublimation toners can also be transferred to, for example, wood, metal, plastic, glass, porcelain, ceramic tiles, stone, PLEXIGLAS®, concrete board, high pressure and low pressure laminate, CORIAN®, etc., by the application of heat. In particular, as shown in FIG. 3, first substrate 71 is placed in contact with second substrate 72, such that mirror image 73 is in contact with second substrate 72. Heat source 74 is then placed in thermal contact with first substrate 71, causing the dye sublimation toners of mirror image 73 to sublime, such that mirror image 73 is transferred to second substrate 72 to form the final image on second substrate 72.

While it is apparent that the invention disclosed herein is well calculated to fulfill the objects stated above, it will be appreciated that numerous modifications and embodiments may be devised by those skilled in the art. Therefore, it is intended that the appended claims cover all such modifications and embodiments that fall within the true spirit and scope of the present invention.

What is claimed is:

1. A method of producing a high resolution image on an electrostatic printer, the method comprising:
(a) providing an electrostatic printer having at least five toner fountains;
(b) providing a set of at least five liquid toners each having a desired color, the set comprising at least one reduced density toner and at least one dark toner, wherein the reduced density toner is either white or has the same color, but a lower color density, as at least one other toner in the set, and the dark toner is either black or has the same color but a higher color density as at least one other toner in the set;
(c) forming an electrostatic image on a substrate that corresponds to that portion of a final image that is formed from one of the toner colors;
(d) developing the electrostatic image with the appropriate color toner; and
(e) forming the final image by repeating (b) and (c) for each color toner, wherein, when reduced density magenta and reduced density cyan toners are used, a reduced density yellow toner is not used with a standard yellow toner.

2. The method of claim I, further comprising selecting the toner set from the group consisting of a set comprising reduced density cyan, dark cyan, reduced density magenta, dark magenta, and yellow toners and a set comprising black, yellow, cyan, magenta, and white toners.

3. The method of claim 1, selecting the toner set comprising reduced density cyan, dark cyan, reduced density magenta, dark magenta, and yellow toners.

4. The method of claim 1, further comprising using dye sublimation toners to develop the image, and transferring the developed image to a second substrate.

5. The method of claim 4, further comprising placing the image on the substrate in contact with the second substrate, and applying heat to transfer the image to the second substrate.

6. The method of claim 1, further comprising using reflective toners to develop the image.

7. A method of producing a high resolution image on an electrostatic printer, the method comprising:
(a) providing an electrostatic printer having at least five toner fountains;
(b) providing a set of at least five liquid toners each having a desired color, the set of liquid toners selected from the group consisting of a set comprising reduced density cyan, dark cyan, reduced density magenta, dark magenta, and yellow toners, wherein the set does not comprise a reduced density yellow toner, and a set comprising black, yellow, cyan, magenta, and yellow toners;
(c) forming an electrostatic image on a substrate that corresponds to at least a portion of that portion of a final image that is formed from one of the toner colors;
(d) developing the electrostatic image with the appropriate color toner; and
(e) forming the final image by repeating (b) and (c) for each color toner.

8. The method of claim 7, selecting the toner set comprising reduced density cyan, dark cyan, reduced density magenta, dark magenta, and yellow toners.

9. The method of claim 7, further comprising using dye sublimation toners to develop the image, and transferring the developed image to a second substrate.

10. The method of claim 9, further comprising placing the image on the substrate in contact with the second substrate, and applying heat to transfer the image to the second substrate.

11. The method of claim 7, further comprising using reflective toners to develop the image.

12. A method of producing a high resolution image on an electrostatic printer, the method comprising providing an electrostatic printer having at least five toner fountains;
(a) providing a different color liquid toner for each of the toner fountains, wherein the different color toners comprise at least reduced density cyan, dark cyan, reduced density magenta, dark magenta, and yellow toners, wherein the set does not comprise a reduced density yellow toner;
(b) forming an electrostatic image on a substrate that corresponds to that portion of a final image that is formed from one of the toner colors;
(c) developing the electrostatic image with the appropriate color toner; and
(d) forming the final image by repeating (b) and (c) for each color toner.

13. The method of claim 12, further comprising using dye sublimation toners to develop the image, and transferring the developed image to a second substrate.

14. The method of claim 13, further comprising placing the image on the substrate in contact with the second substrate, and applying heat to transfer the image to the second substrate.

15. The method of claim 12, further comprising using reflective toners to develop the image.

16. A developed electrostatic image on a substrate, the image comprising at least five layers, each layer formed from one toner in a set of at least five liquid color toners, wherein the set comprises at least one reduced density toner and at least one dark toner, wherein the reduced density toner is either white or has the same color, but a lower color density, as at least one other toner in the set, and the dark toner is either black or has the same color, but a higher color density as at least one other toner in the set, and wherein when one layer is formed from a reduced density magenta toner, and one layer is formed from a reduced density cyan toner, the image is free of any layers formed from a reduced density yellow toner.

17. The electrostatic image of claim 16, wherein the toner set is selected from the group consisting of a set comprising reduced density cyan, dark cyan, reduced density magenta, dark magenta, and yellow toners and a set comprising black, yellow, cyan, magenta, and yellow toners.

18. The electrostatic image of claim 16, wherein the toner set comprises reduced density cyan, dark cyan, reduced density magenta, dark magenta, and yellow toners.

19. The electrostatic image of claim 16, wherein the toner set comprises black, yellow, cyan, magenta, and yellow toners.
